(19) United States
(12) Patent Application Publication
(10) Pub. No.: US 2008/0057310 A1
(43) Pub. Date: Mar. 6, 2008

(54) High-Density Polymer Brush-Coated Hollow Microparticles, Processes For Producing The Same And Applications Of High-Density Polymer Brush-Coated Hollow Microparticles

(76) Inventors: Kohji Ohno, Kyoto (JP); Yoshinobu Tsujii, Kyoto (JP); Takeshi Fukuda, Kyoto (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 10/594,144

(22) PCT Filed: Sep. 1, 2005
(86) PCT No.: PCT/JP05/16047

§ 371 Date: Sep. 26, 2006

(30) Foreign Application Priority Data
Feb. 15, 2005 (JP) 2005-038474

(51) Int. Cl. B32B 3/26; C08G 73/00; C08J 3/24

(52) U.S. Cl. 428/402; 521/189; 521/55

(57) ABSTRACT

The object of the present invention is to provide a process for hollowing a composite microparticle made of high-density grafted chains attached to a microparticle surface without compromising characteristics of prior art, high-density polymer particles of having a narrow particle size distribution and an excellent dispersion stability and to provide, by such a process, a hollow microparticle comprising a high-density polymer brush layer and a hollow portion.

The present inventions provides a process for hollowing a microparticle, by eluting only a microparticle from a composite microparticle made of high-density grafted chains attached to a microparticle surface and provides, by such a process, a hollow microparticle comprising a hollow portion and a high-density polymer brush layer enclosing the hollow portion.

### TECHNICAL FIELD

The present invention relates to a hollow microparticle comprising a hollow portion and a high-density polymer brush layer enclosing the hollow portion and a process for producing the same. In addition, the present invention relates to a method for controlling alignment thereof and applications thereof.

### BACKGROUND ART

Microparticle polymers have shapes which can provide characteristics such as spherization (monodispersing), heteromorphization, porosity (hollowing), complexing, impartment of surface reactivity and so on and are, therefore, used in a wide variety of fields, such as in additives for cosmetics, carrier particles for diagnostic reagents, pharmacy and medicine, information-displaying materials such as liquid crystal spacers, additives for plastics and the like, taking advantage of their submicron sizes.

Hollow polymer microparticles have conventionally been produced by such a process as incorporating a blowing agent in resin particles and then allowing the blowing agent to expand, encapsulating a volatile material in a polymer and then allowing the volatile material to vaporize and expand, or melting a polymer and injecting a gas such as air into the polymer.

By means of such processes, however, it has been difficult to produce predetermined hollow particles in a steady manner. On the other hand, Patent Reference 1 discloses a process for producing hollow particles which comprises preparing a dispersion of monomer components comprising hydrophilic, crosslinkable and/or other monomers coexistent with an oily component, polymerizing the monomers to obtain resin particles and then removing the oily component to provide hollow particles. The mere preparation of a dispersion of monomers and an oily component, however, has a disadvantage that control of hollow structure is highly difficult and inefficient.

In order to solve such a problem, further studies have been conducted for processes for producing hollow microparticles, and processes have been proposed, such as layer-by-layer technique and a process which comprises utilizing copolymerization of divinyl monomers and the like, coating surfaces of microparticles as templates with an organic or inorganic substance and then removing the template microparticles to provide hollow microparticles. Controllability of hollow structures has been improved to some extent, while at least one of the improvement in productivity, the improvement in dispersibility of microparticles and the impartment of functions to microparticles is still insufficient, leaving a number of problems to be addressed.

In addition, Patent Reference 2 discloses hollow macromolecular microparticles in which shells are formed of a crosslinkable polymer and a process for producing the same. According to this process, hollow macromolecular microparticles having a high porosity can be obtained. There is, however, a disadvantage that the shells are so thin that the particles can not be used in applications where their strength is required and nothing of methods for controlling particle strength or for orderly aligning the particles has been disclosed.

Just for reference, the inventors have succeeded in production of a brush-form, high-density polymer particle in which grafted chains extend in a vertical direction from the surface of the particle, by attaching a crosslinkable polymer to the surface of an inorganic particle (SiO₂) through graft polymerization and then performing living radical polymerization and have filed an application (Patent Reference 3). Such composite microparticles made of high-density grafted chains attached to microparticle surfaces can perform alignment control of the microparticles driven by steric repulsion by high-density grafted chains to form colloidal crystals.

Patent literature 1: Japanese Laid-Open Patent Publication No. 1993-125127

Patent literature 2: Japanese Laid-Open Patent Publication No. 2004-190038

Patent literature 3: Japanese Patent Application No. 2004-139213

### DISCLOSURE OF THE INVENTION

### Prroblems to be Solved by the Invention

The present invention is intended to provide a process for hollowing a composite microparticle made of high-density grafted chains attached to a microparticle surface without compromising characteristics of prior art, high-density polymer particles of having a narrow particle size distribution and an excellent dispersion stability and to provide, by such a process, a hollow microparticle comprising a high-density polymer brush layer and a hollow portion.

### Means for Solving the Problems

After conducting a keen examination, the inventors have confirmed that it is possible to obtain a hollow microparticle, by eluting only a microparticle from a composite microparticle made of high-density grafted chains attached to a microparticle surface to hollow the composite microparticle, while retaining characteristics of prior art, high-density polymer particles, to successfully solve the above problems.

Therefore, the present invention provides the following.

(1) A hollow microparticle comprising a hollow portion and a high-density polymer brush layer enclosing the hollow portion.

(2) The hollow microparticle according to (I) wherein the density of chains composing the polymer brush layer is from 0.4 to 1.2 chains/nm².

(3) The hollow microparticle according to (1) or (2) wherein the polymer chain composing the polymer brush layer is a block copolymer of at least one crosslinkable monomer having a crosslinkable functional group and a non-crosslinkable monomer,

blocks of the crosslinkable monomer are located innermost of the polymer brush layer, and

crosslinkable monomer blocks in a polymer chain and the crosslinkable monomer blocks in a discrete polymer chain are crosslinked via a linkage formed by reaction between the crosslinkable functional groups or via a linkage formed by reaction between the crosslinkable functional group and a polyfunctional compound.

(4) The hollow microparticle according to any one of (1) to (3) wherein the crosslinkable monomer in the polymer chain composing the polymer brush layer is acrylic acid, methacrylic acid or an acrylate or methacrylate having a functional group selected from the group consisting of an epoxyalkylene group, an aminoalkylene group, an oxetanylalkylene group and a cinnamoylalkylene group, and

the non-crosslinkable monomer in the polymer chain composing the polymer brush layer is selected from the group consisting of an acrylate derivative, a methacrylate derivative, a styrene derivative, vinyl acetate and acrylonitrile.

(5) The hollow microparticle according to any one of (1) to (4) wherein the molecular weight distribution index of each block of the polymer chain composing the polymer brush layer is from 1 to 1.50.

(6) The hollow microparticle according to any one of (1) to (5) wherein the degree of polymerization of the crosslinkable monomer block in the polymer brush layer is from 10 to 10000, and the degree of polymerization of the non-crosslinkable monomer block in the polymer brush layer is from 10 to 10000.

(7) The hollow microparticle according to any one of (1) to (6) which has a particle size of from 60 nm to 5 μm.

(8) A hollow microparticle comprising a hollow portion and a high-density polymer brush layer enclosing the hollow portion, wherein a polymer chain composing the polymer brush layer is a block copolymer of:

i) a crosslinkable monomer block located at inner part of the polymer brush layer, which is represented by the formula:

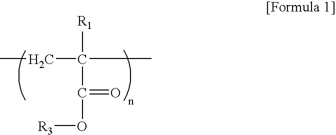

wherein

R₁ is a hydrogen atom or a C₁ to C₆ alkyl group,

R₃ is a crosslinkable functional group represent by the formula:

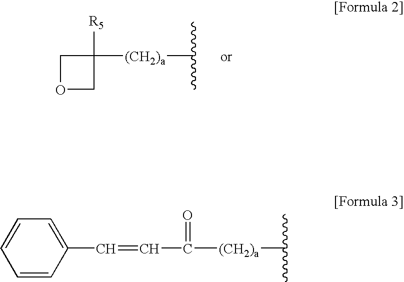

wherein R₅ is a hydrogen atom or a C₁ to C₆ alkyl group, and a is an integer of from 1 to 3, and

n is from 10 to 10000; and

ii) a non-crosslinkable monomer block located at outer part of the polymer brush layer, which is represented by the formula:

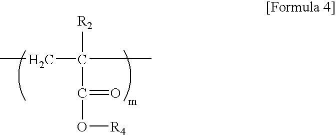

wherein

R₂ is a hydrogen atom or a C₁ to C₆ alkyl group,

R₄ is a hydrogen atom, a C₁ to C₁₂ alkyl group or a phenyl group, and

m is from 10 to 10000; and

wherein crosslinkable monomer blocks in a polymer chain and the crosslinkable monomer blocks in a discrete polymer chain are crosslinked via a linkage formed by reaction between the crosslinkable functional groups.

(9) A hollow microparticle comprising a hollow portion and a high-density polymer brush layer enclosing the hollow portion, wherein a polymer chain composing the polymer brush layer is a block copolymer of:

i) a crosslinkable monomer block located at inner part of the polymer brush layer, which is represented by the formula:

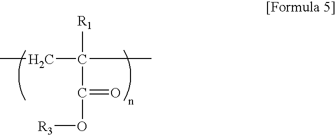

wherein

R₁ is a hydrogen atom or a C₁ to C₆ alkyl group,

R₃ is a hydrogen atom or a crosslinkable functional group represented by the formula:

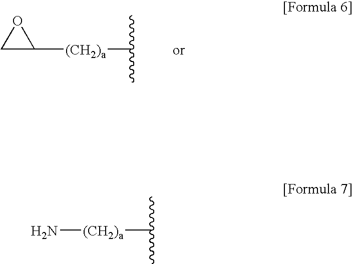

wherein a is an integer of from 1 to 3, and

n is from 10 to 10000; and

ii) a non-crosslinkable monomer block located at outer part of the polymer brush layer, which is represented by the formula:

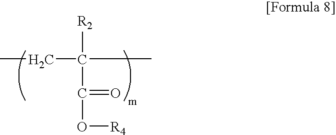

wherein

R₂ is a hydrogen atom or a C₁ to C₆ alkyl group,

R₄ is a hydrogen atom, a C₁ to C₁₂ alkyl group or a phenyl group, and

m is from 10 to 10000; and

wherein crosslinkable monomer blocks in a polymer chain and the crosslinkable monomer blocks in a discrete polymer chain are crosslinked via a linkage formed by reaction between the crosslinkable functional group and a polyfunctional compound; and

wherein, if R₃ is a hydrogen atom, the polyfunctional compound is represented by a formula selected from the group consisting of:

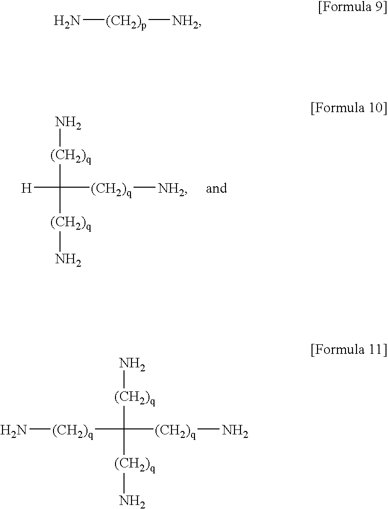

wherein p is an integer of from 1 to 6, and q is an integer of from 1 to 3;

if R₃ is a crosslinkable functional group represented by the formula:

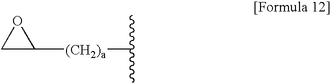

the polyfunctional compound is represented by a formula selected from the group consisting of:

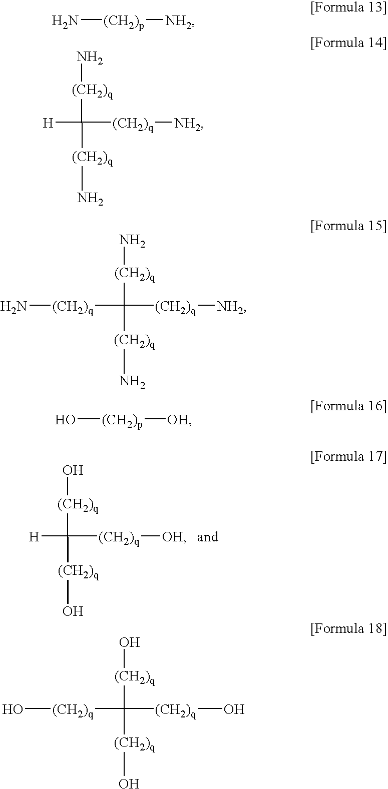

wherein p and q are as defined above; or

if R₃ is a crosslinkable functional group represented by the formula:

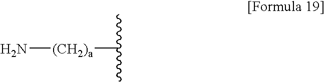

the polyfunctional compound is represented by a formula selected from the group consisting of:

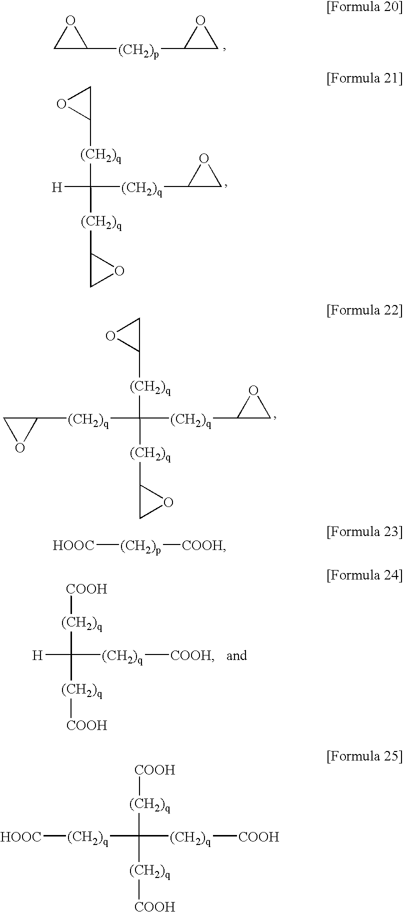

wherein p and q are as defined above.

(10) A process for producing a hollow microparticle comprising a hollow portion and a high-density polymer brush layer enclosing the hollow portion, comprising the steps of:

a) attaching a polymerization initiation group to a microparticle surface;

b) bringing into contact a microparticle having the polymerization initiation group on its surface with a crosslinkable monomer under the conditions for living radical polymerization to obtain a composite microparticle in which a high-density polymer brush layer is attached to the microparticle surface;

c) bringing into contact a crosslinkable polymer brush of the composite microparticle with a non-crosslinkable monomer under the conditions for living radical polymerization to obtain a composite microparticle in which a block copolymer is attached to the microparticle surface;

d) subjecting the composite microparticle in which the block copolymer is attached to the microparticle surface to the conditions for crosslinking reaction; and

e) bringing into contact the composite microparticle in which the block copolymer is attached to the microparticle surface with an eluent under such conditions that the microparticle is only eluted with no influence on the block copolymer to elute only the microparticle.

(11) The process according to (10) wherein the step a) is carried out by bringing into contact a compound represented by the formula:

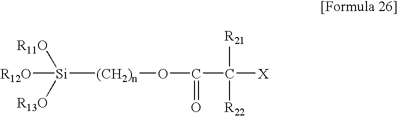

wherein

n is an integer of from 3 to 10,

R₁₁ to R₁₃ independently represent a C₁ to C₃ alkyl,

R₂₁, and R₂₂ independently represent a methyl group or an ethyl group, and

X represents a halogen atom,

with a microparticle of silica, a metal oxide or a metal sulfide under such conditions that the compound and the microparticle may react.

(12) The process according to (10) or (11) wherein the crosslinkable monomer is acrylic acid, methacrylic acid or an acrylate or methacrylate having a functional group selected from the group consisting of an epoxyalkylene group, an aminoalkylene group, an oxetanylalkylene group and a cinnamoylalkylene group, and

the non-crosslinkable monomer is selected from the group consisting of an acrylate derivative, a methacrylate derivative, a styrene derivative, vinyl acetate and acrylonitrile.

(13) The process according to any one of(10) to (12) wherein the step d) is carried out by photo- or heat-treating the composite microparticle in which the block copolymer is attached to the microparticle surface in the presence or absence of an initiator.

(14) The process according to any one of (10) to (13) wherein the step d) is carried out by adding a polyfunctional compound capable of reacting with a crosslinkable functional group in the crosslinkable monomer block.

(15) The process according to any one of (10) to (14) wherein the eluent is an aqueous solution of hydrogen fluoride.

### EFFECT OF THE INVENTION

According to the processes for producing a hollow microparticle of the present invention, a hollow particle, while retaining characteristics of prior art, high-density polymer particles of having a narrow particle size distribution and an excellent dispersion stability, can be obtained.

In addition, any hollow particles may be obtained by the selection of particle shape and size. Further, shape-retaining characteristics (rigid or flexible) of the hollow portion may be controlled by adjusting the degree of polymerization and the like of the crosslinkable polymer for the inner layer, and a sustained release rate and/or intake rate can also be controlled when the hollow portion is to carry or take in a reagent and agent.

Moreover, particle sizes can arbitrarily be designed by controlling the film thickness of the outer, high-density grafted chains.

### BRIEF DESCRIPTION OF THE DRAWINGS

FIG. 1 illustrates an example of synthesis procedure of hollow microparticles according to the present invention. Specifically, a procedure is illustrated in which from a composite microparticle made of macromolecular grafted chains (a block copolymer of PMMA and PEMO, with PMMA blocks at outer part and PEMO blocks at inner part) attached to a silica microparticle surface, a crosslinked gel is obtained by crosslinking reaction of crosslinkable monomer blocks (PEMO blocks), followed by removal of the silica microparticle by HF, to provide a hollow microparticle having a PMMA brush layer.

FIG. 2 illustrates a synthesis procedure and synthesis mechanism of the composite microparticle of FIG. 1 made of macromolecular grafted chains attached to a silica microparticle surface. In the central illustration, an immobilized initiator (BHE) immobilized to SiO₂ is shown. Also shown in the central illustration is a free initiator (EBIB). Subsequently shown is atom transfer radical polymerization (ATRP) process. In the reaction scheme for ATRP in FIG. 2, X is Br or Cl, L is a ligand and M is a monomer. An example of formation of crosslinkable monomer blocks at inner part and non-crosslinkable monomer blocks at outer part by ATRP process is shown in the right-hand illustration. Also shown in the right-hand illustration are free polymers.

FIG. 3 illustrates an example of a crosslinkable monomer composing the crosslinkable monomer blocks in FIG. 1 (3-ethyl-3-methacryloyloxymethyloxetane (EMO)) and a crosslinking reaction mechanism. In the structural formula for EMO, the methacryloyl group has radical polymerizability and the oxetane ring has ring-opening polymerizability.

FIG. 4 shows infrared absorption spectra (absorbance against wavenumber (cm⁻¹ )) for a microparticle grafted with a block copolymer (PEMO-b-PMMA) according to the process of the present invention, before BF₃ treatment (solid line), after BF₃ treatment (broken line) and after HF treatment (dotted line).

FIG. 5 is a transmission electron micrograph of a water surface monolayer film of hollow microparticles according to the present invention. The arrow in the drawing measures 2 μm in length.

### BEST MODE FOR CARRING OUT THE INVENTION

The present invention is now described. It is to be understood that throughout this specification, expressions in singular forms, “a”, “an” and “the” also include plural concepts thereof unless otherwise specified. It is also to be understood that all scientific and technical terms used in this specification have meanings commonly used in the art unless otherwise specified.

(Terms)

Terms used specifically in this specification will now be enumerated with respect to their definitions.

The term “hollow microparticle” used herein means a structure composed of a hollow portion to be defined below and a high-density polymer brush layer enclosing the hollow portion.

The term “high-density” used herein means a macromolecular chain density at an incomparably higher level, which is a density of grafted chains when such macromolecular chains are so dense that steric repulsion may occur between the macromolecular chains. In such a case, the macromolecular chains assume a form stretched nearly to the full extent in a direction perpendicular to the surface. For example, assuming that polymethyl methacrylate chains as grafted chains were stretched straight to the full extent in a direction perpendicular to the surface, a density of 0.4 chains/nm² or more would be attained.

The term “polymer chain” used herein means a chain of two or more molecules, formed by polymerization reaction, stretching from a microparticle surface, and can be used interchangeably with “macromolecular chain” or “macromolecular grafted chain.”

The term “chain density” or “density” used herein means a number of macromolecular chains aligned per unit area (nm²) on a surface. For hollow microparticles according to the present invention, a density at the terminus of the hollow portion side of polymer chains composing a polymer brush layer is referred to as “chain density.”

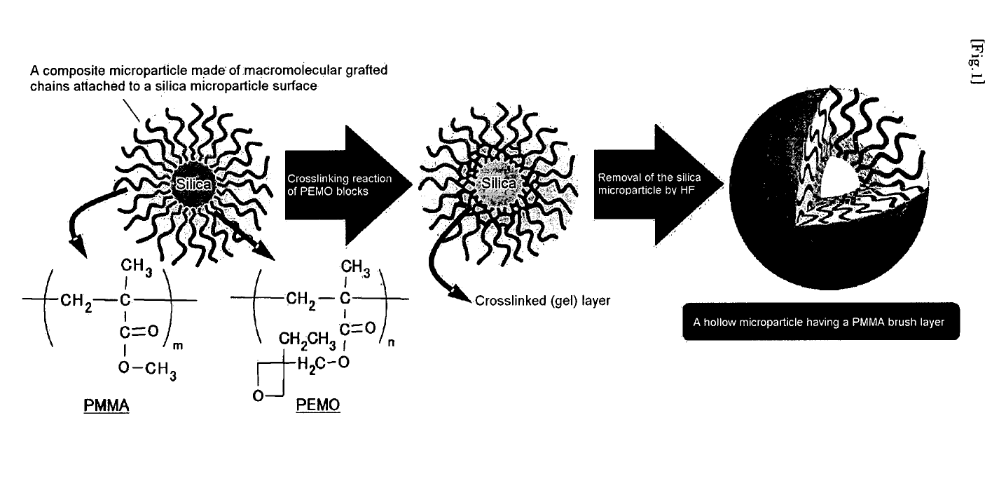

The term “polymer brush layer” used herein means a structure in which individual macromolecular chains in a high density are oriented and aligned in relation to the surface of a “microparticle” or “hollow portion” to be defined below and in which a macromolecular chain is crosslinked with another macromolecular chain (see FIG. 1, for example). A “macromolecular chain” used here may be a homopolymer of crosslinkable monomers or a copolymer of a crosslinkable monomer and a non-crosslinkable monomer.

The term “crosslinking” used herein means a state in which adjacent macromolecular chains are linked by a chemical reaction between crosslinkable functional groups contained in the macromolecular chains or by a chemical reaction between a crosslinkable functional group and a polyfunctional compound, or such a chemical reaction per se. “Link” used here has a binding constant such that individual macromolecules may not disintegrate in eluting only a microparticle from a composite microparticle in which a polymer brush layer is attached to the surface.

The term “polyfunctional compound” used herein means a symmetric or asymmetric organic compound which is responsible for bridging at least two macromolecular chains having crosslinkable functional groups, and has, in one molecule, at least two functional groups (typically, free carboxyl groups, activated carboxyl groups, free amino groups, hydroxyl groups or epoxy groups) capable of reacting with the crosslinkable functional groups contained in the macromolecular chains. In the present invention, any combinations of “crosslinkable functional groups” and “polyfunctional compounds” may be appropriately selected in the range conceivable to those skilled in the art.

The term “crosslinkable monomer” used herein means a monomer having, in addition to polymerizable groups, crosslinkable functional groups in its side chain. On the other hand, a polymer in which polymerizable groups contained in crosslinkable monomers have been polymerized and crosslinkable functional groups remain unreacted is referred to as a “crosslinkable polymer.”

The term “block copolymer” used herein means a polymer including polymer chains obtained by homopolymerization of a first polymer and polymer chains obtained by homopolymerization of a second polymer. For example, a block copolymer of PEMO and PMMA is referred to as “PEMO-b-PMMA” in this specification.

The term “crosslinkable monomer block” used herein means a polymer block made of polymerized crosslinkable monomers.

The term “non-crosslinkable monomer” used herein means a monomer having polymerizable groups and absolutely no crosslinkable functional groups. On the other hand, a polymer of non-crosslinkable monomers is referred to as a “non-crosslinkable polymer.”

The term “non-crosslinkable monomer block” used herein means a polymer block made of polymerized non-crosslinkable monomers. The term “hollow portion” used herein means a space enclosed by a polymer brush layer in a hollow microparticle as defined above, into which artificial or biological substances, singly or in combination, capable of being in the form of a gas, liquid (solution, dispersion, etc.), gel, semi-solid or solid may be filled.

The term “microparticle” used herein means a bare microparticle before a polymer brush layer as defined above is attached to its surface, and may be used in distinction from a “hollow microparticle” as defined above. The term “microparticle” used herein may be used interchangeably with the term “template microparticle.” Any solid particle with a particle size of from 50 nm to 1 μm, being monodispersed and capable of being eluted by an eluent which will not adversely affect (degrade, break, etc.) the polymer brush layer, may be used as a microparticle for the present invention. Representative examples include, but not limited to, silicon oxides, such as silica; noble metals, such as Au (gold), Ag (silver), Pt (platinum) and Pd (palladium); transition metals, such as Ti, Zr, Ta, Sn, Zn, Cu, V, Sb, In, Hf, Y, Ce, Sc, La, Eu, Ni, Co, Fe and the like, inorganic substances thereof, such as oxides or nitrides; or organic substances thereof.

The term “composite microparticle” used herein means a microparticle formed of a “polymer brush layer” as defined above attached to a microparticle surface, and is used herein in distinction from a “microparticle” and “hollow microparticle” as defined above.

The term “living radical polymerization” used herein means a polymerization such that, for a polymerization reaction with no or negligible chain transfer or termination reaction, the produced polymer will retain polymerization activity at the terminus even after the termination of the reaction so that a polymerization reaction may be reinitiated upon addition of monomers. Characteristics of living radical polymerization include a capability of synthesizing polymers having any average molecular weights by adjusting the concentration ratio between monomers and a polymerization initiator, an extremely narrow distribution of molecular weights of produced polymers and applicability to block copolymers. Living radical polymerization is herein abbreviated as “LRP.” In addition, examples of monomers capable of radical polymerization for composing grafted chains include MMA (methyl methacrylate), styrene and vinyl acetate.

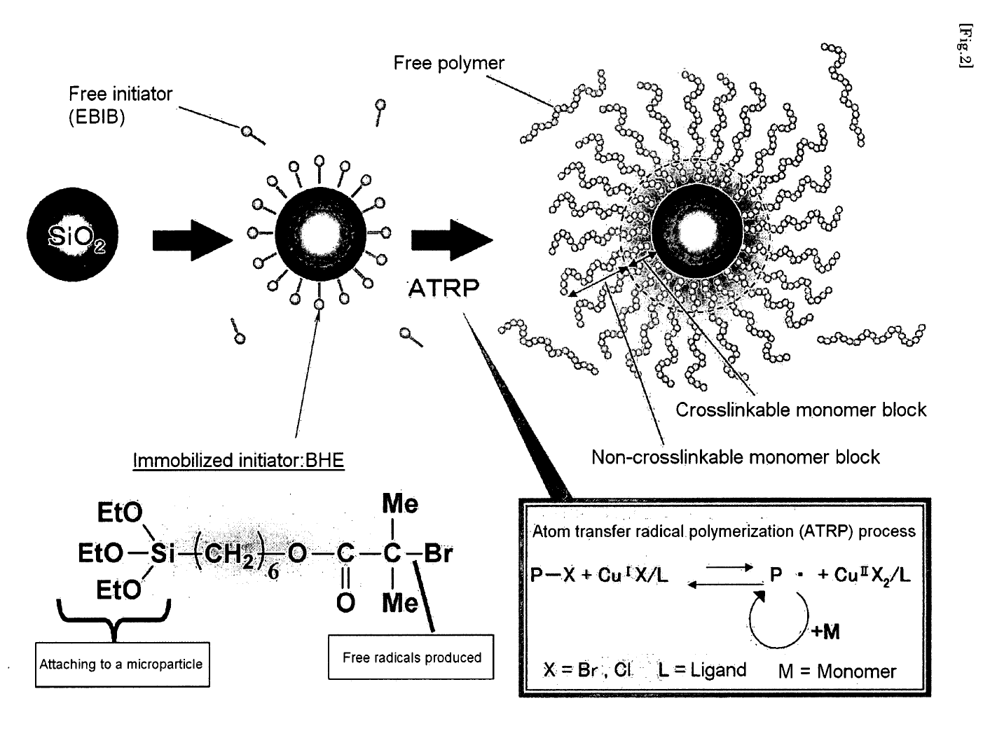

Representative examples of living radical polymerization used in the present invention include atom transfer radical polymerization (ATRP) (see FIG. 2). For example, substrate surfaces of silica microparticles are immersed in a solvent and then, in the presence or absence of a free initiator (for example, p-toluenesulfonyl chloride (abbreviated as TsCl) or ethyl 2-bromoisobutyrate (abbreviated as EBIB) or the like) that is not immobilized on the microparticle surfaces, methyl methacrylate (MMA), styrene (St) or the like is subjected to atom transfer radical polymerization (ATRP) using a copper halide (Cu^{l}X)/ligand (L) complex. A molecule-terminal halogen (P-X) is extracted by the Cu^{l}X/L complex to reversibly produce a growing radical (P), to which the monomer is added so that a molecular weight distribution may be regulated by sufficiently frequent reversible activation and inactivation.

According to the present invention, in order to avoid coupling between microparticles which may occur during living radical polymerization, measures are taken for lowering as much as possible the charge concentration of microparticles having an initiator immobilized on their surfaces. As such, when the initiator is insufficient in the system for graft polymerization to proceed at a high density from the microparticle surfaces, it is preferable to allow a free initiator as shown above to coexist during the polymerization in addition to the immobilized initiator (see FIG. 2). The ratio of concentration of an immobilized initiator in relation to the total concentration of initiators present in the system is preferably from 1 to 50%, more preferably from 1 to 20%, and most preferably 10%.

The term “under the conditions for living radical polymerization” used herein means to adopt polymerization conditions as appropriately selected by those skilled in the art such that living radical polymerization may surely and well proceed on the basis of polymerization initiation group provided on the surfaces of microparticles.

The term “polymerization initiation group” used herein means a substance which is added in a small amount to monomers to function as an initiator of a polymerization reaction, and any substances may be used without limitation as long as such function is provided.

The term “hollowing” or “hollowing treatment” used herein means a process for removing (for example, eluting or liquating) only a microparticle from a composite microparticle in which a polymer brush layer is attached to a microparticle surface, without adversely affecting the polymer brush layer.

(Description of Preferred Embodiment)

Preferred embodiments of the present invention will be described below. It is to be understood that the embodiments to be presented below are provided for better understanding of the invention and that the scope of the invention should not be limited to the description below. It is, therefore, obvious that those skilled in the art may make modifications to the invention within the scope thereof in the light of the description herein.

In one aspect, the present invention provides a hollow microparticle comprising a hollow portion and a high-density polymer brush layer enclosing the hollow portion. Thus, the hollow microparticle includes the high-density polymer brush layer having a structure in which individual macromolecular chains are oriented and aligned in a high density in relation to the surface of the hollow portion and in which crosslinkable functional groups contained in a macromolecular chain is crosslinked with other crosslinkable functional groups of another macromolecular chain, therefore, providing an advantage of having a much higher particle strength in comparison to conventional hollow microparticles not having such a polymer brush structure.

The density of polymer chains composing the polymer brush layer is preferably from 0.4 to 1.2 chains/nm², more preferably from 0.7 to 1.2 chains/nm², even more preferably from 0.8 to 1.2 chains/nm², yet more preferably from 0.9 to 1.2 chains/nm², and most preferably from 1.0 to 1.2 chains/nm². When the density of polymer chains is below 0.4 chains/nm , the brush structure will be sparse, not allowing steric repulsion to occur between adjacent macromolecular chains, with a disadvantage that the chains can not assume a fully stretched form and the particle strength will decrease. In addition, it is unfavorable for application for carrying or taking in reagents or agents into the hollow portion. Also, when the density of polymer chains is above 1.2 chains/nm², the chain density will be so high that the hollow particle may have a poor stability.

Also, by such brush-like formation of high-density polymer chains on a spherical surface, another advantage may be obtained that crosslinking reaction to be described below may easily be performed.

In one preferred embodiment, at least part of the polymer chains composing the polymer brush layer is crosslinked.

Preferably, 10% or more of the total number of polymer chains composing the polymer brush layer are crosslinked, more preferably 50% or more of the polymer chains are crosslinked, even more preferably 80% or more of the polymer chains are crosslinked, and yet more preferably 90% or more of the polymer chains are crosslinked. Particularly preferably, substantially all of the polymer chains are crosslinked. Preferably one or more crosslinks on average exist per polymer chain, more preferably 1.5 or more crosslinks on average exist per polymer chain, and more preferably two or more crosslinks on average exist per polymer chain.

In a more preferable embodiment, the polymer chain composing the polymer brush layer is a block copolymer of at least one crosslinkable monomer and a non-crosslinkable monomer and blocks of the crosslinkable monomer are located innermost of the polymer brush layer. In addition, crosslinkable monomer blocks in a polymer chain and the crosslinkable monomer blocks in a discrete polymer chain are crosslinked via a linkage formed by reaction between the crosslinkable functional groups or via a linkage formed by reaction between the crosslinkable functional group and a polyfunctional compound (i.e. crosslinking agent). Specifically, the polymer chains are crosslinked directly or via a crosslinking agent. Thus, the inner layer serving as a scaffolding for the polymer brush layer is reinforced by the crosslinking reaction as described above (see FIG. 1, for example) so that the whole polymer brush layer may be stabilized. By controlling the fraction occupied by crosslinked monomer units relative to the total number of monomer units of macromolecular chains composing the polymer brush layer of a hollow microparticle, the strength of the hollow microparticle according to the present invention can be controlled. The fraction, occupied by crosslinked monomer units, of the total number of monomer units of macromolecular chains composing the hollow microparticle according to the present invention is preferably from 5 to 50%, more preferably from 10 to 45% and particularly preferably from 15 to 40%. For example, when a polymer chain is composed of a total of 100 monomers, preferably from 5 to 50 of them are crosslinked, more preferably from 10 to 45 of them are crosslinked and particularly preferably from 15 to 40 of them are crosslinked.

As in this embodiment, if crosslinking is made at the inner side (that is, where chains are closer to adjacent chains) it will be easier to maintain the brush in an upright position even at the outer side (that is, where the chains are more spaced from the adjacent chains) so that the particle size as well as the stability and dispersibility of the whole polymer brush may be retained and improved.

In particular, when the chain density is high as described above, the distance between chains is smaller so that, by the crosslinking reaction, the shape of a particle may easily be stabilized and the rigidity of a particle may easily be improved. Then, by an improvement in the rigidity of the particle, it will be easy to remove a template microparticle (silica, for example) contained in the hollow portion during production. On this basis, formation of a polymer brush in the form of a hollow microparticle has been enabled. Specifically, when crosslinking is not performed, polymer chains will tend to be discrete in removing a microparticle within, making the formation of a hollow microparticle extremely difficult and, even if it was formed, it would be difficult to retain the hollow shape; however, when the crosslinking described above is performed, an extremely stable hollow microparticle can easily be obtained.

Additionally, according to the present invention, by adjusting the degree of crosslinking and the like of the crosslinkable polymer for the inner layer, shape-retaining characteristics (rigid or flexible) of the hollow portion may advantageously be controlled. Also, when the hollow portion is to carry or take in a reagent and agent, their sustained release rate and/or intake rate can also be controlled. Furthermore, particle sizes can arbitrarily be designed by controlling the film thickness of the non-crosslinkable polymer of the outer layer.

Crosslinkable monomers preferred for use in the present invention include, but not limited to, acrylic acid, methacrylic acid or an acrylate or methacrylate having a functional group selected from the group consisting of an epoxyalkylene group, an aminoalkylene group, an oxetanylalkylene group and a cinnamoylalkylene group. “Alkyl group” in the epoxyalkylene, aminoalkylene, oxetanylalkylene and cinnamoylalkylene groups means a C₁ to C₆ straight or branched divalent alkylene group, particularly preferred examples including methylene (—CH₂—) and ethylene (—CH₂CH₂—).

Non-crosslinkable monomers preferred for use in the present invention include, but not limited to, an acrylate derivative, a methacrylate derivative, a styrene derivative, vinyl acetate and acrylonitrile.

Hollow microparticles can be synthesized relatively easily using any of the crosslinkable monomers and non-crosslinkable monomers mentioned above, with an advantage of being suitable for industrial mass production.

The molecular weight distribution index of each block of a polymer chain in a hollow microparticle according to the present invention is preferably from 1 to 1.50, and more preferably from 1 to 1.30. Such ideal or nearly ideal monodispersed hollow microparticles can easily be obtained by the process for producing hollow microparticles according to the present invention.

The degree of polymerization of the crosslinkable monomer block composing the polymer brush layer of the hollow microparticle according to the present invention is preferably from 10 to 10000, and more preferably from 100 to 5000. The degree of polymerization of the non-crosslinkable monomer block is preferably from 10 to 10000, and more preferably from 100 to 5000.

According to the process for producing hollow microparticles of the present invention, within the range of a particle size of from 60 nm to 5 μm, the particle size of a hollow microparticle, the film thickness of the polymer brush layer and the chain density of polymer chains can freely be controlled.

Also, as an initial stage of production of hollow microparticles, in order to graft polymerize at a high density from the surface of a microparticle as a template, the particle size of the template microparticle is preferably from 50 nm to 1 μm. If the particle size of the template microparticle was below 50 nm, the curvature of the particle would have an influence in the graft polymerization from the microparticle surface, lowering the density of macromolecular chains at the polymer brush layer. If the particle size of the template microparticle was above 1 μm, dispersion of composite microparticles or hollow microparticles in a solvent would unfavorably be difficult.

In one preferred embodiment, the present invention provides a hollow microparticle comprising a hollow portion and a high-density polymer brush layer enclosing the hollow portion, wherein a polymer chain composing the polymer brush layer is a block copolymer of:

i) a crosslinkable monomer block located at inner part of the polymer brush layer, which is represented by the formula:

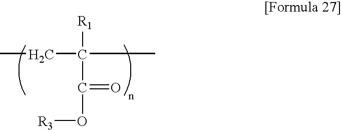

wherein

R₁ is a hydrogen atom or a C₁ to C₆ alkyl group, and more preferably a hydrogen atom or a methyl group,

R₃ is a crosslinkable functional group represented by the formula:

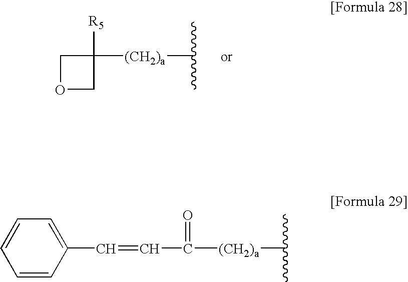

wherein R₅ is a hydrogen atom or a C₁ to C₆ alkyl group, and more preferably a hydrogen atom, a methyl group or an ethyl group and a is an integer of from 1 to 3, and

n is from 10 to 10000; and

ii) a non-crosslinkable monomer block located at outer part of the polymer brush layer, which is represented by the formula:

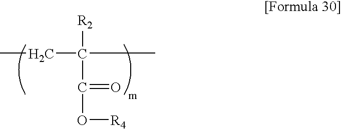

wherein

R₂ is a hydrogen atom or a C₁ to C₆ alkyl group, and more preferably a hydrogen atom or a methyl group,

R₄ is a hydrogen atom, a C₁ to C₁₂ alkyl group or a phenyl group, and more preferably a hydrogen atom, and

m is from 10 to 10000; and

wherein crosslinkable monomer blocks in a polymer chain and the crosslinkable monomer blocks in a discrete polymer chain are crosslinked via a reaction between the crosslinkable functional groups.

In another preferred embodiment, the present invention provides a hollow microparticle comprising a hollow portion and a high-density polymer brush layer enclosing the hollow portion, wherein a polymer chain composing the polymer brush layer is a block copolymer of:

i) a crosslinkable monomer block located at inner part of the polymer brush layer, which is represented by the formula:

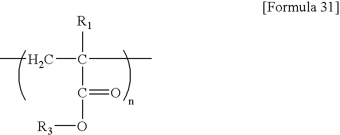

wherein

R₁ is a hydrogen atom or a C₁ to C₆ alkyl group, and more preferably a hydrogen atom or a methyl group,

R₃ is a hydrogen atom or a crosslinkable functional group represented by the formula:

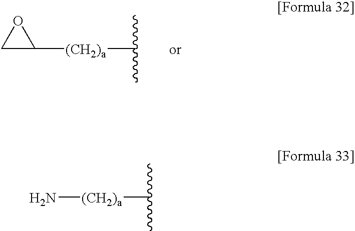

wherein a is an integer of from 1 to 3, and

n is from 10 to 10000; and

ii) a non-crosslinkable monomer block located at outer part of the polymer brush layer, which is represented by the formula:

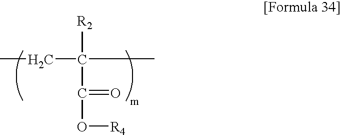

wherein

R₂ is a hydrogen atom or a C₁ to C₆ alkyl group, and more preferably a hydrogen atom or a methyl group,

R₄ is a hydrogen atom, a C₁ to C₁₂ alkyl group or a phenyl group, and more preferably a hydrogen atom, and

m is from 10 to 10000; and

wherein crosslinkable monomer blocks in a polymer chain and the crosslinkable monomer blocks in a discrete polymer chain are crosslinked via a reaction between the crosslinkable functional group and a polyfunctional compound; and

wherein, if R₃ is a hydrogen atom, the polyfunctional compound is represented by a formula selected from the group consisting of:

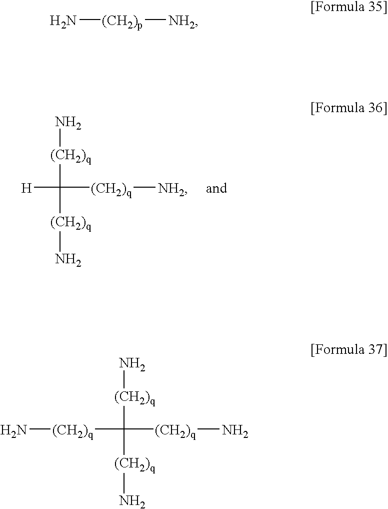

wherein p is an integer of from 1 to 6, and q is an integer of from 1 to 3;

if R₃ is a crosslinkable functional group represented by the formula:

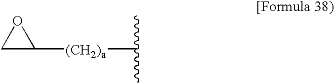

the polyfunctional compound is represented by a formula selected from the group consisting of:

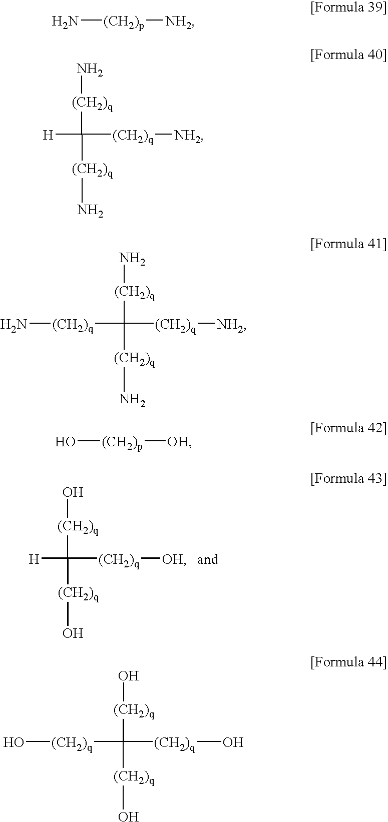

wherein p and q are as defined above; or

if R₃ is a crosslinkable functional group represented by the formula:

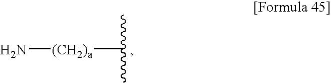

the polyfunctional compound is represented by a formula selected from the group consisting of:

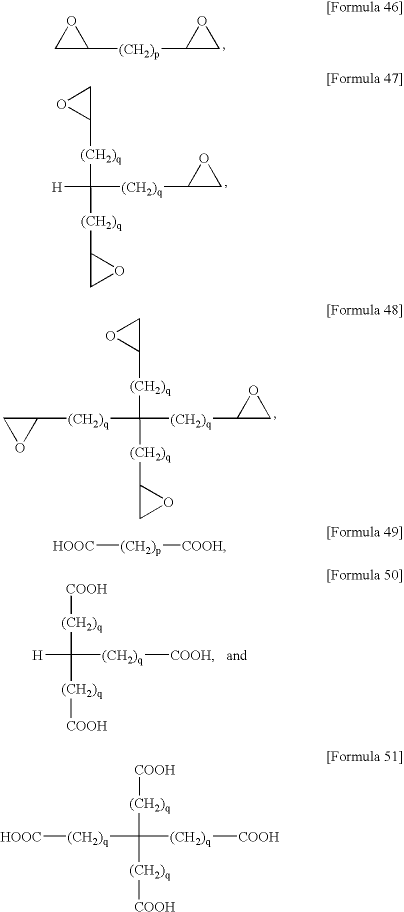

wherein p and q are as defined above.

The term “alkyl group” used herein refers to a monovalent group produced from an aliphatic hydrocarbon such as methane, ethane and propane (alkanes) which is deprived of one hydrogen atom, generally represented by CₙH₂ₙ—wherein n is a positive integer. An alkyl group can be straight or branched.

The term “phenyl group” used herein is a C₆ aromatic cyclic hydrocarbon, in other words, a functional group produced from a benzene which is deprived of one H.

In another aspect, the present invention provides a process for producing a hollow microparticle comprising a hollow portion and a high-density polymer brush layer enclosing the hollow portion, comprising the steps of:

a) attaching a polymerization initiation group to a microparticle surface;

b) bringing into contact a microparticle having the polymerization initiation group on its surface with a crosslinkable monomer under the conditions for living radical polymerization to obtain a composite microparticle in which a high-density polymer brush layer is attached to the microparticle surface;

c) bringing into contact a crosslinkable polymer brush of the composite microparticle with a non-crosslinkable monomer under the conditions for living radical polymerization to obtain a composite microparticle in which a block copolymer is attached to the microparticle surface;

d) subjecting the composite microparticle in which the block copolymer is attached to the microparticle surface to the conditions for crosslinking reaction; and

e) bringing into contact the composite microparticle in which the block copolymer is attached to the microparticle surface with an eluent under such conditions that the microparticle is only eluted with no influence on the block copolymer to elute only the microparticle.

In a preferred embodiment, the step a) is carried out by bringing into contact an immobilized initiator represented by the formula:

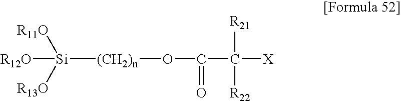

and a template microparticle of silica, a metal oxide or a metal sulfide (preferably, a template microparticle of silica, in particular) under such conditions that the compound and the microparticle may react. In the formula, the spacer chain length n is preferably an integer of from 3 to 10, more preferably an integer of from 4 to 8, and most preferably 6. R₁ is preferably a C₁ to C₃ alkyl group, and more preferably a methyl group or an ethyl group. R₂ is preferably a methyl group or an ethyl group. X is preferably a halogen atom, and in particular Br.

According to the present invention, silica microparticles are preferred for use as microparticles for immobilizing an immobilized initiator because they facilitate the hollowing process and a polar solvent is used for appropriately dispersing silica microparticles. Conventional immobilized initiators, chlorosilane-based initiators, have been unable to be used with a polar solvent because of low solubility, and a high-density graft polymerization has been impossible. In order to solve this problem, according to the present invention, use of alkoxysilane-based immobilized initiators highly compatible with a polar solvent well dispersing silica microparticles allows to attain high-density graft polymerization.

The polymerization initiation group-containing silane coupling agents as described above can be synthesized according to the process described in Patent Literature 3. The microparticles thus obtained, having polymerization initiation group on their surfaces, are contacted with a crosslinkable monomer listed above under the conditions for living radical polymerization, to thereby obtain composite microparticles in which high-density polymer brush layers are attached to the microparticle surfaces (step b)). The crosslinkable monomer to be contacted with the microparticles having polymerization initiator substrates on their surfaces may be singular or plural in kind; however, it is preferably singular in order to obtain monodispersibility of the crosslinkable polymer brush layers.

The crosslinking reaction carried out in the step d) may be any conventionally known crosslinking reaction. Energy necessary for carrying out the crosslinking reaction may be provided by any method. Examples include light, heat, electron radiation and electromagnetic wave.

In a preferred embodiment, the step d) in the process for production according to the present invention is carried out by photo- or heat-treating the composite microparticle in which the block copolymer is attached to the microparticle surface in the presence or absence of an initiator. When an acrylate or methacrylate having an oxetanylalkylene group is used as a crosslinkable monomer, photo- or heat-treatment will be carried out in the presence of an initiator. When an acrylate or methacrylate having a cinnamoylalkylene group is used as a crosslinkable monomer, photo- or heat-treatment will be carried out in the absence of an initiator.

In another preferred embodiment, the step d) in the process for production according to the present invention is carried out by adding a polyfunctional compound capable of reacting with a crosslinkable functional group in the crosslinkable monomer block.

The eluent used for the hollowing treatment (for example, step e) ) is an aqueous solution of hydrogen fluoride, the concentration of which can be selected as appropriate by those skilled in the art.

During the process for producing hollow microparticles according to the present invention, an intermediate product or end product obtained at each step above can be isolated by removing foreign substances (unreacted raw materials, byproducts, solvents, etc.) from a reaction solution by a method commonly used in the art (for example, extraction, distillation, washing, concentration, precipitation, filtration, drying, etc.) followed by an appropriate combination of post-treatment methods commonly used in the art (for example, adsorption, elution, distillation, precipitation, deposition, chromatography, etc.).

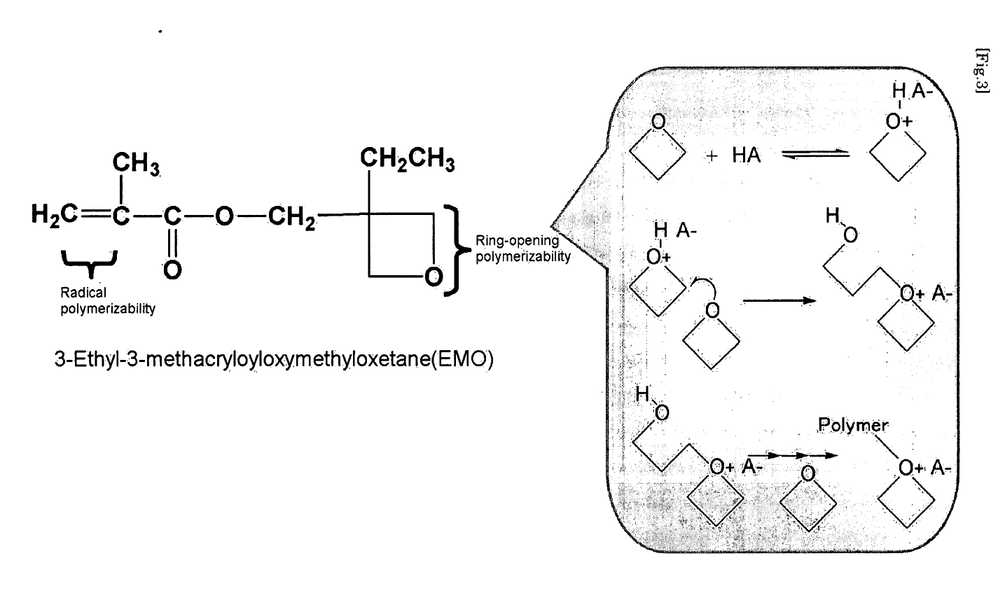

The hollow microparticles obtained according to the present invention can be confirmed by transferring a water surface film of these microparticles to a grit for transmission electron microscopes (abbreviated as TEM) to observe with a TEM. FIG. 3 shows a TEM photograph of a water surface monolayer film of hollow microparticles according to the present invention (the average particle size of the silica particles is 740 nm and the number average molecular weights of PEMO and PMMA blocks composing the polymer brush layers of the hollow microparticles are 388000 and 194000 respectively). This confirmed that the hollow microparticles according to the present invention had formed a monoparticle film without two-dimensional aggregation.

All references cited herein, such as scientific documents, patents and patent applications are herein incorporated by reference in their entirety to the same extent as if each reference was specifically indicated to be incorporated by reference.

As so far described, the present invention has been described using the preferred embodiments thereof, but it should not be limited to such embodiments. It is recognized that the scope of the invention is limited only by the claims. It is understood that those skilled in the art, reading the description of specific preferred embodiments of the invention, can work equivalent scopes in the light of the description of the invention and technical common knowledge. It is to be understood that all patents, patent applications and literatures cited herein are herein incorporated by reference in their contents to the same manner as if they were specifically indicated to be incorporated by reference.

### EXAMPLES

### Example 1

### Introduction of Initiation Group to Silica Microparticle Surfaces

A dispersion of silica microparticles (Nippon Shokubai, average particle size 740 nm) in ethanol (7.7% by weight, 30 mL) was added to a mixed solution of 28% aqueous ammonia solution (13.9 g) and ethanol (200 mL). After agitating the solution at 40° C. for two hours, 6-(2-bromo-2-methylpropionyloxy)hexyltriethoxy-silane (2 g) dissolved in ethanol (10 mL) was added dropwise and agitation was carried out at 40° C. for 18 hours. Thereafter, silica microparticles were recovered by a centrifuge, washed with ethanol and anisole and then stored in anisole.

### Example 2

### Preparation of Hollow Microparticles

Hollow microparticles were synthesized according to the procedure as follows (FIG. 1). To the dispersion of silica microparticles having polymerization initiation group in anisole (4 g) prepared in Example 1, 3-ethyl-3-methacryloyloxy-methyloxetane (EMO, 10 g) and, as a free initiator, ethyl 2-bromoisobutyrate (EBIB, 3.5 mg) were mixed and dissolved gas was replaced with argon. To this mixture, a solution, previously replaced with argon, of Cu (I) Br (13 mg)/4,4′-dinonyl-2,2′-dipyridyl (dNbipy, 74 mg) complex in anisole (6 g) was added in a glove box and, after hermetically sealing, polymerization was carried out in a temperature-controlled shaking bath at 60° C. for 24 hours. The obtained poly(EMO)(PEMO)-grafted silica microparticles (PEMO-SiP) were washed with acetone to remove free polymers grown from the free initiator. Next, PEMO-SiP (0.4 g) was mixed with methyl methacrylate (MMA, 40 g) and EBIB (13 mg) and dissolved gas was replaced with argon. To this mixture, Cu (I) Br (66 mg)/dNbipy (545 mg) complex in anisole previously replaced with argon was added in a glove box and, after hermetically sealing, polymerization was carried out in a temperature-controlled shaking bath at 70° C. for ten hours. The grafted silica microparticles were washed with acetone to remove free polymers grown from the free initiator, to thereby synthesize silica microparticles grafted with a block copolymer (PEMO-b-PMMA) consisting of PEMO and poly(MMA)(PMMA). The block copolymer-grafted silica microparticles (0.2 g) were dispersed in dichloromethane (10 g) and dissolved gas was replaced with argon. This dispersion was transferred to a glove box, BF₃.OEt₂ (0.1 g) as a ring-opening reaction initiator was added and agitation was carried out at room temperature for 18 hours. The microparticles were washed with toluene and recovered as a dispersion in toluene. To this dispersion in toluene (0.4% by weight, 50 g), hydrogen fluoride (HF) diluted with water (10% by weight, 50 g) and, as a phase transfer catalyst, tri-n-octylmethylammonium chloride (0.5 g) were added and vigorous agitation was carried out for 15 hours to elute silica microparticles. After washing the toluene phase with aqueous hydrogen bicarbonate solution and then with water, hollow microparticles were recovered by a centrifuge.

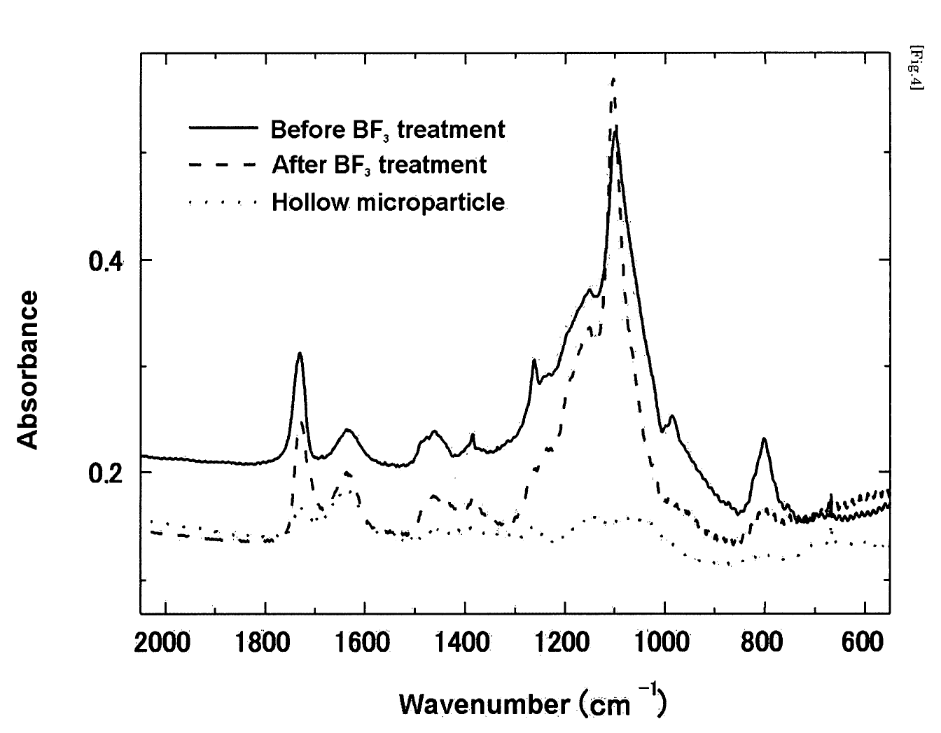

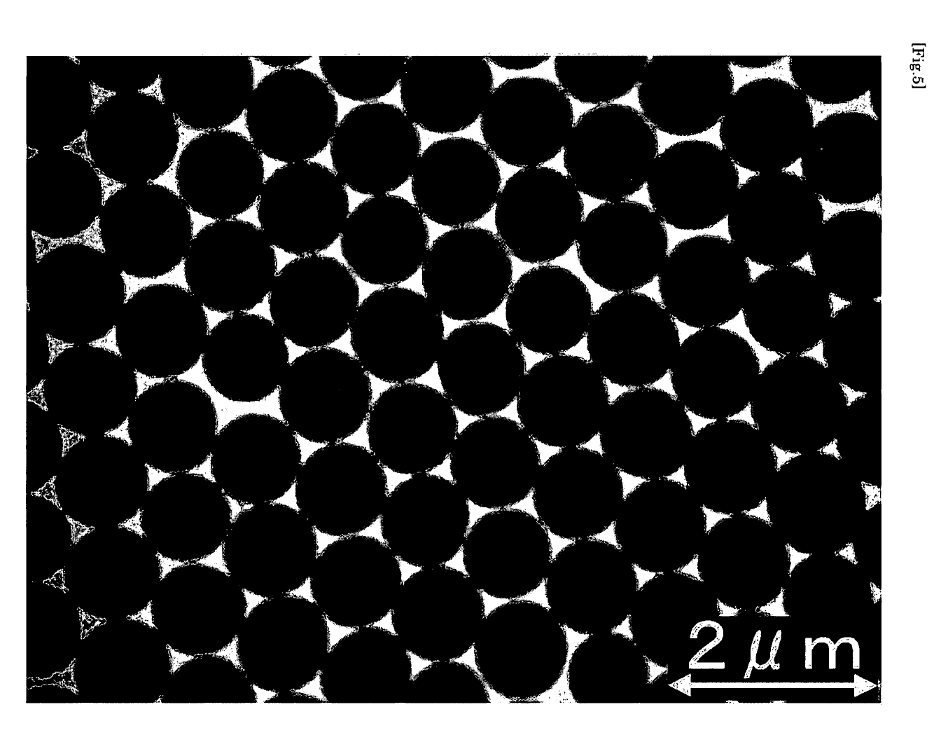

The number average molecular weights of PEMO and PMMA blocks of the block copolymer grafted to the silica microparticle surfaces were 388000 and 194000 respectively, and the molecular weight distribution indices were 1.21 and 1.40 respectively. Infrared absorption spectra of the microparticles before BF₃ treatment, after BF₃ treatment and after HF treatment are shown in FIG. 4. After BF₃ treatment, the peak derived from an oxetane ring (990 cm⁻¹) decreased, indicating that oxetane ring-opening reaction had facilitated the crosslinking reaction of the PEMO blocks. After HF treatment, the peak derived from Si—O (1100 cm⁻¹) disappeared, indicating that the silica microparticles had been eluted. A transmission electron micrograph of the microparticles after HF treatment is shown in FIG. 5. The color at the center of each microparticle appears pale, confirming a hollow shape. As a result of dynamic light scattering determination of microparticles before crosslinking and hollow microparticles, their particles sizes and standard deviations are approximately the same in value, indicating that the microparticles retain high dispersibility without aggregation during the process of preparing the hollow microparticles. This is supposedly due to that the PEMO and PMMA blocks were separated by high distensibility inherent to the high-density polymer brushes, with the PMMA blocks acting as protective layers for preventing crosslinking between the microparticles.

### INDUSTRIAL APPLICABILITY

According to the processes for producing hollow microparticles of the present invention, hollow particles, while retaining characteristics of prior art, high-density polymer particles of having a narrow particle size distribution and an excellent dispersion stability, can be obtained. Also, any hollow microparticles may be obtained by the selection of particle shape and size. In addition, by adjusting the degree of crosslinking and the like of the crosslinkable polymer for the inner layer, shape-retaining characteristics (rigid or flexible) of the hollow portion may be controlled and, when the hollow portion is to carry or take in a reagent and agent, their sustained release rate and/or intake rate can also be controlled. Furthermore, particle sizes can arbitrarily be designed by controlling the film thickness of the high- density grafted chains at the outer side.

The hollow microparticles provided by the present invention have applicability in the fields or as the products enumerated below:

1) Microparticles whose functions rely on macromolecular materials (for example, biodegradable particles, etc.)

2) Microparticles whose surfaces control functions (for example, affinity particles, adsorbents, scatterers, catalysts, etc.)

3) Microparticles whose functions can be controlled by inclusions (quantum dots, fluorophores, pigments, dyestuff, drugs, magnetic substances, CMP (chemical mechanical polishing) abrasives, microreactors, heat insulators, etc.)

4) Microparticles whose functions are provided by regularity of arrangement (photonic crystals, diffraction gratings, light modulating devices, electronic papers, materials for waveguides)

5) Microparticles for providing dynamic functions (particle pumps, etc.)

1. A hollow microparticle comprising a hollow portion and a high-density polymer brush layer enclosing the hollow portion.

2. The hollow microparticle according to claim 1, wherein the density of chains composing the polymer brush layer is 0.4 to 1.2 chains/nm².

3. The hollow microparticle according to claim 1, wherein the polymer chain composing the polymer brush layer is a block copolymer of at least one crosslinkable monomer having a crosslinkable functional group and a non-crosslinkable monomer,
blocks of the crosslinkable monomer are located innermost of the polymer brush layer, and
crosslinkable monomer blocks in a polymer chain and the crosslinkable monomer blocks in a discrete polymer chain are crosslinked via a linkage formed by reaction between the crosslinkable functional groups or via a linkage formed by reaction between the crosslinkable functional groups and a polyfunctional compound.

4. The hollow microparticle according to claim 3, wherein the crosslinkable monomer is acrylic acid, methacrylic acid or an acrylate or methacrylate having a functional group selected from the group consisting of an epoxyalkylene group, an aminoalkylene group, an oxetanylalkylene group and a cinnamoylalkylene group, and
the non-crosslinkable monomer is selected from the group consisting of an acrylate derivative, a methacrylate derivative, a styrene derivative, vinyl acetate and acrylonitrile.

5. The hollow microparticle according to claim 2, wherein the molecular weight distribution index of each block of the polymer chain is from 1 to 1.50.

6. The hollow microparticle according to claim 3, wherein the degree of polymerization of the crosslinkable monomer block is from 10 to 10000, and the degree of polymerization of the non-crosslinkable monomer block is from 10 to 10000.

7. The hollow microparticle according to claim 1, which has a particle size of from 60 nm to 5 μm.

8. A hollow microparticle comprising a hollow portion and a high-density polymer brush layer enclosing the hollow portion, wherein a polymer chain composing the polymer brush layer is a block copolymer of:
i) a crosslinkable monomer block located at inner part of the polymer brush layer, which is represented by the formula: 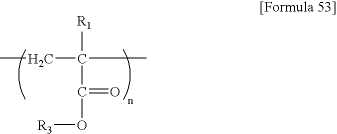
wherein
R₁ is a hydrogen atom or a C₁ to C₆ alkyl group,
R₃ is a crosslinkable functional group represent by the formula: 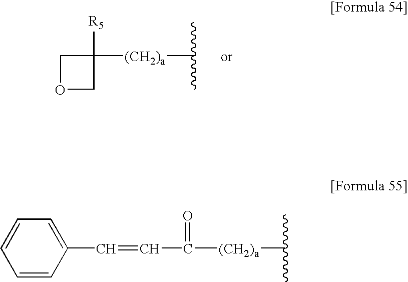
wherein R₅ is a hydrogen atom or a C₁ to C₆ alkyl group, and a is an integer of from 1 to 3, and
n is from 10 to 10000; and
ii) a non-crosslinkable monomer block located at outer part of the polymer brush layer, which is represented by the formula: 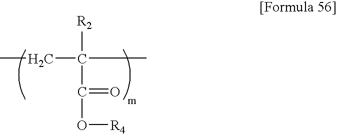
wherein
R₂ is a hydrogen atom or a C₁ to C₆ alkyl group,
R₄ is a hydrogen atom, a C₁ to C₁₂ alkyl group or a phenyl group, and
m is from 10 to 10000; and
wherein crosslinkable monomer blocks in a polymer chain and the crosslinkable monomer blocks in a discrete polymer chain are crosslinked via a linkage formed by reaction between the crosslinkable functional groups.

9. A hollow microparticle comprising a hollow portion and a high-density polymer brush layer enclosing the hollow portion, wherein a polymer chain composing the polymer brush layer is a block copolymer of:
i) a crosslinkable monomer block located at inner part of the polymer brush layer, which is represented by the formula: 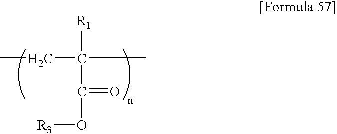
wherein
R₁ is a hydrogen atom or a C₁ to C₆ alkyl group,
R₃ is a hydrogen atom or a crosslinkable functional radical group represented by the formula: 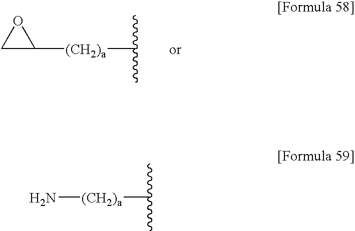
wherein a is an integer of from 1 to 3, and
n is from 10 to 10000; and
ii) a non-crosslinkable monomer block located at outer part of the polymer brush layer, which is represented by the formula: 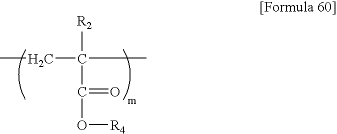
wherein
R₂ is a hydrogen atom or a C₁ to C₆ alkyl group,
R₄ is a hydrogen atom, a C₁ to C₁₂ alkyl group or a phenyl group, and
m is from 10 to 10000; and
wherein crosslinkable monomer blocks in a polymer chain and the crosslinkable monomer blocks in a discrete polymer chain are crosslinked via a linkage formed by reaction between the crosslinkable functional group that is the carboxyl radical or the crosslinkable functional radical and a polyfunctional compound; and
wherein, if R₃ is a hydrogen atom, the polyfunctional compound is represented by a formula selected from the group consisting of: 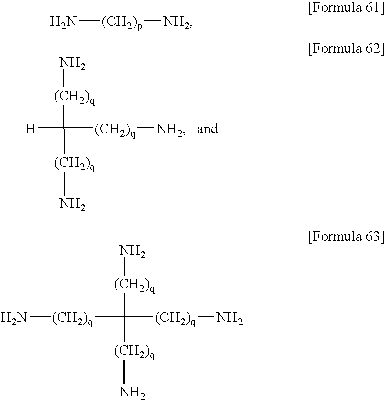
wherein p is an integer of from 1 to 6, and q is an integer of from 1 to 3;
if R₃ is a crosslinkable functional radical represented by the formula: 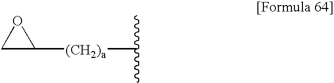
the polyfunctional compound is represented by a formula selected from the group consisting of: 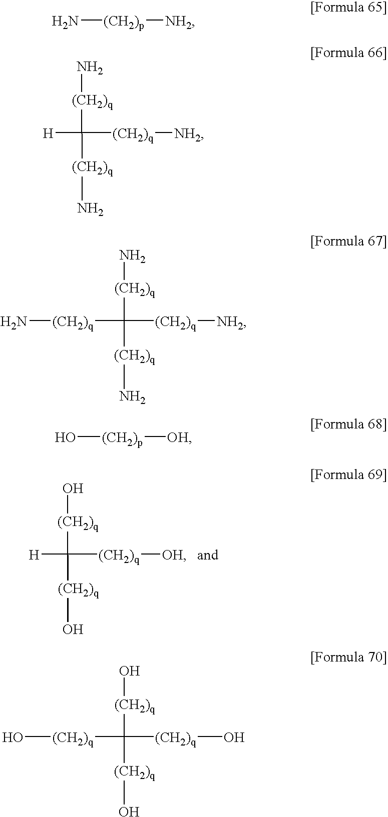
wherein p and q are as defined above; or
if R₃ is a crosslinkable functional radical group represented by the formula: 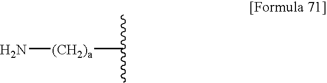
the polyfunctional compound is represented by a formula selected from the group consisting of: 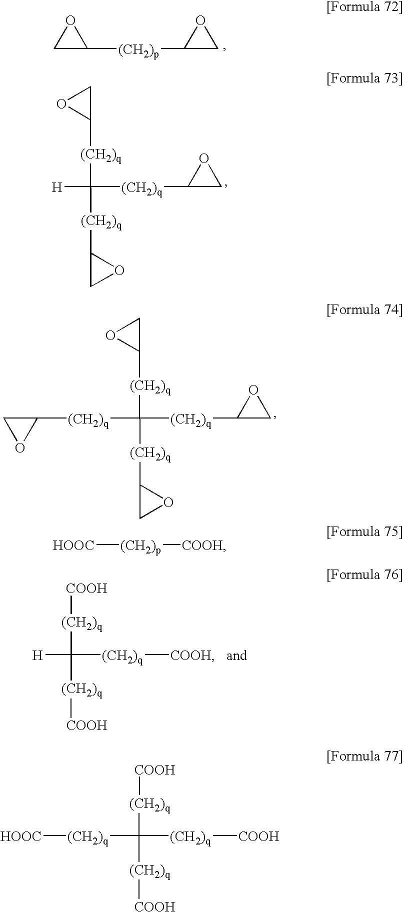
wherein p and q are as defined above.

10. A process for producing a hollow microparticle comprising a hollow portion and a high-density polymer brush layer enclosing the hollow portion, comprising the steps of:
a) attaching a polymerization initiation group to a microparticle surface;
b) bringing into contact a microparticle having the polymerization initiation group on its surface with a crosslinkable monomer under the conditions for living radical polymerization to obtain a composite microparticle in which a high-density polymer brush layer is attached to the microparticle surface;
c) bringing into contact a crosslinkable polymer brush of the composite microparticle with a non-crosslinkable monomer under the conditions for living radical polymerization to obtain a composite microparticle in which a block copolymer is attached to the microparticle surface;
d) subjecting the composite microparticle in which the block copolymer is attached to the microparticle surface to the conditions for crosslinking reaction; and
e) bringing into contact the composite microparticle in which the block copolymer is attached to the microparticle surface with an eluent under such conditions that the microparticle is only eluted with no influence on the block copolymer to elute only the microparticle.

11. The process according to claim 10, wherein the step a) is carried out by bringing into contact a compound represented by the formula: 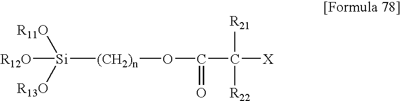
wherein
n is an integer of from 3 to 10,
R₁₁ to R₁₃ independently represent a C₁ to C₃ alkyl,
R₂₁ and R₂₂ independently represent a methyl group or an ethyl group, and
X represents a halogen atom,
with a microparticle of silica, a metal oxide or a metal sulfide under such conditions that the compound and the microparticle may react.

12. The process according to claim 11, wherein
the crosslinkable monomer is acrylic acid, methacrylic acid or an acrylate or methacrylate having a functional group selected from the group consisting of an epoxyalkylene group, an aminoalkylene group, an oxetanylalkylene group and a cinnamoylalkylene group, and
the non-crosslinkable monomer is selected from the group consisting of an acrylate derivative, a methacrylate derivative, a styrene derivative, vinyl acetate and acrylonitrile.

13. The process according to claim 10, wherein the step d) is carried out by photo- or heat-treating-the composite microparticle in which the block copolymer is attached to the microparticle surface in the presence or absence of an initiator.

14. The process according to claim 10, wherein the step d) is carried out by adding a polyfunctional compound capable of reacting with a crosslinkable functional group in the crosslinkable monomer block.

15. The process according to claim 10, wherein the eluent is an aqueous solution of hydrogen fluoride.
